(19) United States
(12) Patent Application Publication
(10) Pub. No.: US 2025/0062309 A1
(43) Pub. Date: Feb. 20, 2025

(54) Process for Solvent-Free Electrode Production and Electrode

(71) Applicant: Bayerische Motoren Werke Aktiengesellschaft, Muenchen (DE)

(72) Inventors: Desiree GRIESSL, Muenchen (DE); Korbinian HUBER, Muenchen (DE)

(21) Appl. No.: 18/723,507

(22) PCT Filed: Feb. 14, 2023
(86) PCT No.: PCT/EP2023/053576

§ 371 Date: Jun. 24, 2024

(30) Foreign Application Priority Data
Mar. 21, 2022 (DE) 10 2022 106 527.8

(51) Int. Cl. H01M 4/04; H01M 4/02; H01M 4/1391; H01M 4/485; H01M 4/62

(52) U.S. Cl. CPC H01M 4/0404; H01M 4/0411; H01M 4/0435; H01M 4/1391; H01M 4/485; H01M 4/623; H01M 4/625; H01M 2004/028

(57) ABSTRACT

One form of a method for solvent-free electrode production comprises: providing mixture constituents for production of a coating material, where at least one mixture constituent is a fibrillatable material; processing the mixture constituents in a multishaft extruder to create the coating material, wherein the fibrillatable material is at least partly fibrillated and the mixture constituents are bound, especially without the use of solvents; and applying the coating material to a carrier foil.

### BACKGROUND AND SUMMARY

The present disclosure relates to a process for solvent-free electrode production and to an electrode for an electrical energy storage cell.

In the production of electrodes for energy storage cells, for example lithium-ion cells, carrier foils, also known as current collectors, are coated with a coating material on one or both sides. Presently, this is often carried out with suspensions of active material in aqueous or organic solvents. This is both energy-intensive and cost-intensive. Especially solvent recovery and drying are exceptionally energy-intensive. Drying additionally entails high plant cost and complexity. Attempts are therefore increasingly being made to implement the coating in a solvent-free fashion. In this connection, DE 10 2017 298 220 A1, for example, discloses a process for producing a dry film in which a dry powder mixture is processed into the dry film by a roll apparatus comprising a first roll and a second roll, wherein the first roll rotates at a higher speed than the second roll and the dry film is stored on the first roll. For manufacturing suitable for large-scale production, the process described therein is however less suitable. In addition, the properties of the “dry film” taught therein also do not appear to be optimally adjustable.

### SUMMARY

It is accordingly an object of the present disclosure to specify a process for solvent-free electrode production and an electrode for an electrical energy storage cell, wherein the process allows optimal adjustment of the properties of the electrodes coupled with the highest possible quality and is suitable for large-scale production.

In some implementations, this object is achieved by a process according to claim 14 and by an electrode according to claim 25. Further advantages and features are apparent from the subclaims and from the description and the accompanying FIGURE.

According to the disclosure, one form of a process for solvent-free electrode production comprises the steps of:
providing various mixture constituents for producing a coating material for an electrode of an energy storage cell, for example a lithium-ion cell, wherein at least one mixture constituent is a fibrillatable material;
processing the mixture constituents in a multi-screw extruder to generate the coating material/to produce the coating material, wherein the fibrillatable material is at least partially fibrillated;
applying the coating material to a carrier foil.

Advantageously, the use of a multi-screw extruder makes it possible to realize a continuous mixing process which allows an enhancement in productivity and a reduction in costs and energy demand compared to batch mixing processes or semicontinuous processes, such as for example in a jet mill. The use of jet mills for example can additionally result in degradation of the electrochemically active components (in particular of intercalation graphites but also other materials, such as oxides and silicon materials), since the subjection to stress necessary for fibrillation of the binder also brings about a grinding of the remaining components. In the present case, the fibrillatable mixture constituent is advantageously the binder which permits solvent-free electrode production. It has in the present case proven particularly advantageous that the degree of fibrillation may be precisely adjusted via the multi-screw extruder. A series of parameters are available to this end, for example process temperature, throughput, speed of rotation and the configuration of the employed kneading and/or mixing elements in the multi-screw extruder.

Following processing in the multi-screw extruder, the coating material is present in powder form. Such powders include particles, granulates etc. The binder component is present in fibrillated form. The particle size of the aforementioned elements is advantageously likewise adjustable via the multi-screw extruder.

The powder mixture comprising fibrillated binder may be processed with a roll apparatus (calender) in the first roll nip into a self-supporting electrode film which is either directly laminated onto a metallic current collector foil (precoated/treated or untreated foil made of copper or aluminum, expanded metals etc.) or is first pressed to the desired thickness and density via further rolls (multi-roll apparatus). It is also possible to carry out a subsequent fibril formation and an alignment of the fibrils in the first nip by running the rolls at different speeds, wherein the layer formed adheres to the roll that is rotating faster and from there can be directly transferred to a current collector foil.

In one embodiment, a process comprises the steps of:
processing the coating material into a self-supporting coating film in a roll apparatus; and
applying the coating film to the carrier foil.

The self-supporting coating film may be wound after production and unwound and used as required, for example by application to an appropriate carrier foil, also known as a current collector. In one embodiment the coating material which is in the form of a powder is pressed by a hot roll system to afford the self-supporting coating film. This may be followed by post-calendering. As mentioned, the self-supporting electrode/coating film may be wound and stored. In a next step the coating film may be laminated onto a current collector foil or carrier foil. To this end, the current collector or carrier foil may have been provided with a primer or adhesion promoter. In one embodiment, the primer may be a polymer (polyvinyl acetate—PVA, carboxymethylcellulose—CMC or the like), and optionally, a conductivity additive (carbon black, carbon nanotubes—CNTs or the like). In one embodiment, the surface of the current collector is additionally etched.

In an alternative embodiment, a process comprises the step of:
producing/forming a coating film immediately on or at the carrier foil in a roll apparatus.

The forming of the coating film and the application to the carrier foil are advantageously carried out in the same step.

In one embodiment, a roll apparatus is used to align the fibrils (already present) in the coating material. Alternatively or in addition, further fibrils may also be generated. This is made possible by operating the roll apparatus comprising a plurality of rolls at different roll speeds.

In a preferred embodiment, the multi-screw extruder is especially a twin-screw extruder.

The multi-screw extruder/twin-screw extruder preferably employs kneading elements or both kneading and mixing elements. As mentioned at the outset, the form of the kneading elements has a decisive effect on the commixing of the mixture constituents, and especially also on fibril formation. The geometry of the kneading elements thus represents an important parameter which influences production of the coating material. The geometry optimal in each case must generally be determined on a case-by-case basis, since further parameters such as the aforementioned process temperature or else the drive power/throughput of the multi-screw extruder are likewise decisive and the parameters may also interact with one another.

The above also applies to the employed mixing elements and to their geometries.

In one embodiment, the fibrillatable mixture constituent/fibrillatable binder component is Teflon or in particular PTFE (polytetrafluoroethylene). In one embodiment, the mixture constituents also comprise two or more fibrillatable mixture constituents, wherein further fibrillatable constituents include for example PVDF (polyvinylidene fluoride) or PE (polyethylene).

In one embodiment, a process comprises the step of:
processing the mixture constituents in the multi-screw extruder at temperatures greater than 120° C. (>120° C.).

The fibrillation of the binder is favored by elevated temperature, such as for example a temperature >120° C. Advantageously, the same extent of fibril formation requires lower shear forces at relatively high temperatures than at low temperatures. The use of a multi-screw extruder additionally allows better heat transfer to the mixture constituents to be commixed. Compared to jet mills fibrillation may therefore be adjusted more precisely and without degradation of the electrochemical active material

Kneading elements in particular effect fibrillation of the binder. TME elements (toothed mixing elements) may additionally be used to vary the particle size of the resulting granulates/particles and to produce a particle structure advantageous for dry coating. In a preferred embodiment the multi-screw extruder comprises not only conveying elements but also mixing elements and/or kneading elements. The aforementioned TME elements are in this context also referred to as “conveying mixing elements”.

In one embodiment, a process comprises the step of:
treating, in particular comminuting, the coating material prior to coating.

In one embodiment, a comminutor (mixer, disperser, cutter, mill or the like) is additionally employed after the extrusion of the powder mixture for a possible further adjustment of particle size. Comminution may be effected via a system connected directly to the extruder or via an external comminutor.

In one embodiment, a process comprises the step of:
introducing the mixture constituents into the multi-screw extruder as a mixture.

That is to say, in one embodiment the mixture constituents are already premixed and are introduced into the multi-screw extruder as a preprepared mixture.

In one embodiment, the mixture is produced in a tumble mixer. However, the use of such an apparatus is to be understood as being merely exemplary.

Alternatively, the mixture constituents are supplied to the multi-screw extruder individually/separately from one another. The mixing is thus effected only in the multi-screw extruder and not beforehand.

The disclosure further relates to an electrode for an electrical energy storage cell produced by the process according to the disclosure, wherein the mixture constituents comprise: electrochemically active material, conductivity additive and a fibrillatable constituent. Preferred conductivity additives include inter alia: carbon black, (conductivity) graphite or carbon nanotubes (CNT).

In a preferred embodiment, the electrochemically active material is cathode material, the conductivity additive is a conductivity carbon black, and the fibrillatable constituent is PTFE. Preferred cathode materials are: LCO (lithium cobalt oxide), LMS or LMO (lithium manganese oxide spinel), NMC or NCM (lithium nickel cobalt manganese), LFP (lithium iron phosphate), NCA (lithium nickel cobalt aluminum oxide) or NCMA (nickel cobalt manganese aluminum).

In a preferred embodiment, the electrochemically active material comprises 92-99% by weight, the conductivity additive 0.5-5% by weight and the fibrillatable constituent 0.5-3% by weight.

In a particularly preferred embodiment, the electrochemically active material comprises 95% by weight, the conductivity additive 3% by weight and the fibrillatable constituent 2% by weight.

In one embodiment, a mixture is produced by homogenizing in a tumble mixer. As mentioned above, direct metering of the individual components into the multi-screw extruder is alternatively possible. In one embodiment, the mixture is metered into a multi-screw extruder having a screw diameter of 20 mm and a length-to-diameter ratio L/D of 40 and having a process zone that has been heated to 160° C. At a speed of 420 revolutions per minute and a mass throughput of 3.5 kg per hour, the PTFE binder is fibrillated and thus allows further processing of the resulting dry mixture into self-supporting electrodes/coating films and battery electrodes.

### BRIEF DESCRIPTION OF THE DRAWINGS

Further advantages and features will be apparent from the following description of an embodiment with reference to the accompanying FIGURE.

FIG. 1 shows a schematic view of an embodiment of a process.

### DETAILED DESCRIPTION OF THE DRAWINGS

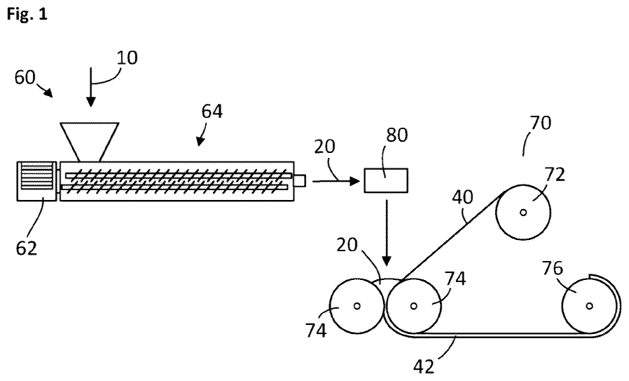

FIG. 1 shows a schematic view of a multi-screw extruder 60 comprising a drive 62 and a process zone 64 which in the present case comprises two screw elements. The multi-screw extruder 60 is supplied with a mixture 10 comprising mixture constituents. Processing/commixing and in particular fibril formation is advantageously effected in the multi-screw extruder 60 present. In the present case the process zone 64 is operated at relatively high temperatures, wherein “relatively high temperatures” is to be understood as meaning temperatures of >120° C., for example of 160° C. according to a preferred embodiment.

The fibrillation of the binder component in the mixture is favored by the elevated temperature. Advantageously, the same extent of fibril formation requires lower shear forces at such temperatures than at low temperatures. For possible further adjustment of the particle size of the coating material, a further apparatus for treatment of the coating material may be employed after the multi-screw extruder 60 as is also shown here, cf. reference numeral 80. The apparatus for treatment 80 may be for example a mixer, a disperser or a cutter, by means of which the (pulverulent) coating material is further comminuted. This is followed by production of the coating film in an appropriate roll apparatus 70. In the present case a carrier foil 40 is unwound from a first roll 72 and passed to two second rolls 74. These form a coating film 42 directly on the carrier foil 40. It is shown in the schematic view that the electrode thus produced is rewound on a third roll 76.

It is alternatively also possible to process the coating material 20 into a self-supporting coating film which may be wound and processed at a later time in a first roll nip, cf. for example the two second rolls 74.

### LIST OF REFERENCE NUMERALS

10 mixture
20 coating material
40 carrier foil
42 coating film, electrode film
60 multi-screw extruder
62 drive
64 process zone
70 roll apparatus
72 first roll
74 second roll
76 third roll
80 apparatus for treatment

1-13. (canceled)

14. A method for solvent-free electrode production, the method comprising:
providing mixture constituents for producing a coating material, wherein at least one of the mixture constituents is a fibrillatable material;
processing the mixture constituents in a multi-screw extruder to generate the coating material, wherein the fibrillatable material is at least partially fibrillated; and
applying the coating material to a carrier foil.

15. The method of claim 14, further comprising:
processing the coating material into a self-supporting coating film in a roll apparatus; and
applying the coating film to the carrier foil.

16. The method of claim 14, further comprising:
producing a coating film directly on the carrier foil in a roll apparatus.

17. The method of claim 14, wherein the multi-screw extruder is a twin-screw extruder.

18. The method of claim 14, further comprising:
using kneading elements, or kneading and mixing elements, in the multi-screw extruder.

19. The method of claim 14, wherein the fibrillatable constituent is Teflon or PTFE.

20. The method of claim 14, wherein the mixture constituents are processed in the multi-screw extruder at temperatures greater than 120° C.

21. The method of claim 14, further comprising:
treating the coating material before coating.

22. The method of claim 21, wherein treating the coating material before coating comprises comminuting the coating material before coating.

23. The method of claim 14, further comprising:
introducing the mixture constituents into the multi-screw extruder as a mixture.

24. The method of claim 23, further comprising:
producing the mixture in a tumble mixer.

25. An electrode for an electrical energy storage cell produced according to the method of claim 14, wherein the mixture constituents comprise: electrochemically active material, conductivity additive and a fibrillatable constituent.

26. The electrode according to claim 25, wherein the electrochemically active material is cathode material, the conductivity additive is a conductivity carbon black and the fibrillatable constituent is PTFE.

27. The electrode according to claim 25, wherein the electrochemically active material comprises 92% to 99% by weight, the conductivity additive comprises 0.5% to 5% by weight and the fibrillatable constituent comprises 0.5% to 3% by weight.
